(19) United States
(12) Patent Application Publication
(10) Pub. No.: US 2008/0105720 A1
(43) Pub. Date: May 8, 2008

(54) Adjustable bicycle basket support frame

(76) Inventor: Sheng-Kai Lee, Taichung (TW)

Correspondence Address: Troxell Law Office Pllc, Suite 1404, 5205 Leesburg Pike, Falls Church, VA, 22041, US

(21) Appl. No.: 11/592,230

(22) Filed: Nov. 3, 2006

(51) Int. Cl. B62J 39/00; B62J 11/00; B62J 7/00; B62J 9/00

(52) U.S. Cl. 224/422

(57) ABSTRACT

An adjustable bicycle basket support frame configured with a hollow inverted U-shaped tube and rod members respectively inserted into two end portions of the inverted U-shaped tube; and screws are used to fixedly secure assembled component members. End portions of the two rod members are respectively secured to a hub of a bicycle front fork, and the rod members are adjustably extended or retracted up and down within the inverted U-shaped tube to reach a bottom portion of a bicycle basket, thereby enabling supporting or securing of the bicycle basket. Accordingly, the present invention enables installation to all models of bicycles and bicycle baskets, effectively increasing compatibility of the bicycle basket support frame and strengthening supporting force for the bicycle basket.

### BACKGROUND OF THE INVENTION

(a) Field of the Invention

The present invention relates to an adjustable bicycle basket support frame, and more particularly to a retractable tube support member fixedly secured to a bicycle, enabling up and down height adjustment for supporting or securing a bicycle basket to all bicycle models, and improving compatibility of the support frame.

(b) Description of the Prior Art

A bicycle not only serves as a means of transportation in daily life, but is also extensively used in outdoor recreation activities. However, because of its simple structure, it lacks a configuration for loading articles. Hence, a user additionally fits a basket to the bicycle in order to accommodate personal needs, and which can be used to load articles therein. The majority of fitted bicycle baskets seen in the current market can be classified into two major types including fixed types and detachable types. The fixed types are primarily structured to include a fixing mount disposed on the bicycle stem, and a side of the bicycle basket is fixedly secured to the fixing mount. Furthermore, an inverted U-shaped support frame 50 of prior art (see FIG. 6) is fixedly secured to a hub of the bicycle front fork, and a top bar 51 of the inverted U-shaped support frame 50 is fixedly joined to a bottom portion of the bicycle basket. Moreover, holes 52 defined at bottom ends of the support frame 50 are fixedly secured to the hub, thereby supporting the bicycle basket and providing the bicycle basket with a relatively good supporting force. However, because of the numerous external forms, dimensions, models and styles of bicycle baskets and bicycles, thus, there are a large range of lengths for the inverted U-shaped support frame supporting the bicycle basket, causing inconvenience in stocking materials and in production and manufacture.

Another bicycle basket support frame 60 of prior art (see FIG. 7) is provided with two support rods 61 and 62, a top end of each of which is defined with a hole 63, and bottom ends are respectively defined with a plurality of fixing holes 64 at different heights. Moreover, left and right protruding pieces 66 respectively defined with holes are located on a bottom portion of a bicycle basket 65, and screws 67 are used to respectively penetrate the holes of the protruding pieces 66 and the holes 63 of the support rods 61, 62, thereby joining the bicycle basket 65 to the two support rods 61, 62. The fixing holes 64 at the bottom ends of the support rods 61, 52 enable adjustment to an appropriate height and joining and fixedly securing to a hub of the bicycle front fork, thereby providing for loading articles within the bicycle basket 65. However, because the fixing holes 64 of the support rods 61, 62 are interspaced, thus, it is relatively difficult to adjust levelness of the bicycle basket when assembling.

Hence, in light of the aforementioned derived shortcomings, the inventor of the present invention, having accumulated years of experience in related arts, attentively and circumspectly carried out extensive study, testing and innovative improvement to ultimately design an adjustable support frame applicable for use on all types of bicycle baskets and bicycles, and which strengthens supporting force for the bicycle basket, thereby assuredly providing the adjustable support frame with advanced effectiveness.

### SUMMARY OF THE INVENTION

A primary objective of the present invention is to provide an adjustable bicycle basket support frame that is applicable for use with all models and dimensions of bicycles and fitting of bicycle baskets thereto, thereby increasing compatibility of the support frame and strengthening supporting force for the bicycle basket.

Another objective of the present invention is to enable the production and manufacture of a bicycle basket support frame having single dimensions, thereby reducing manufacturing cost, and increasing production efficiency and stock convenience.

In order to achieve the aforementioned objectives, the adjustable bicycle basket support frame of the present invention is structured to comprise an inverted U-shaped tube and two rod members. Screw holes that penetrate to the interior are respectively defined in two end circumferential portions of the inverted U-shaped tube, and screws respectively screw into the screw holes. Furthermore, the two rod members are respectively inserted into the two end portions of the inverted U-shaped tube, and a securing portion provided with a through hole is located at a bottom end of each of the rod members. Accordingly, the rod members of the inverted U-shaped tube are adjustably extended or retracted up and down to a required height, thereby enabling installation to all models of bicycles and bicycle baskets, effectively increasing compatibility of the bicycle basket support frame, strengthening supporting force for the bicycle basket and further improving convenience and efficiency of stock material and production and manufacture.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exploded structural view according to the present invention.

FIG. 2 shows a schematic view of the present invention assembled to a bicycle hub.

FIG. 3 shows a schematic view of the present invention fitted to a bicycle.

FIG. 4 shows an exploded structural view of another embodiment according to the present invention.

FIG. 5 shows a schematic view of the second embodiment fitted to a bicycle according to the present invention.

FIG. 6 shows an external elevational view of an inverted U-shaped support frame of prior art used to support a bicycle basket.

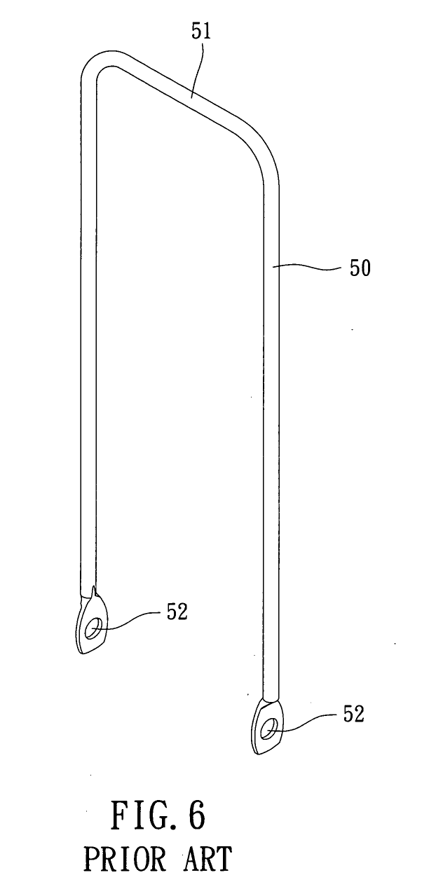

FIG. 7 shows an exploded elevational view of another support frame of prior art used to support a bicycle basket.

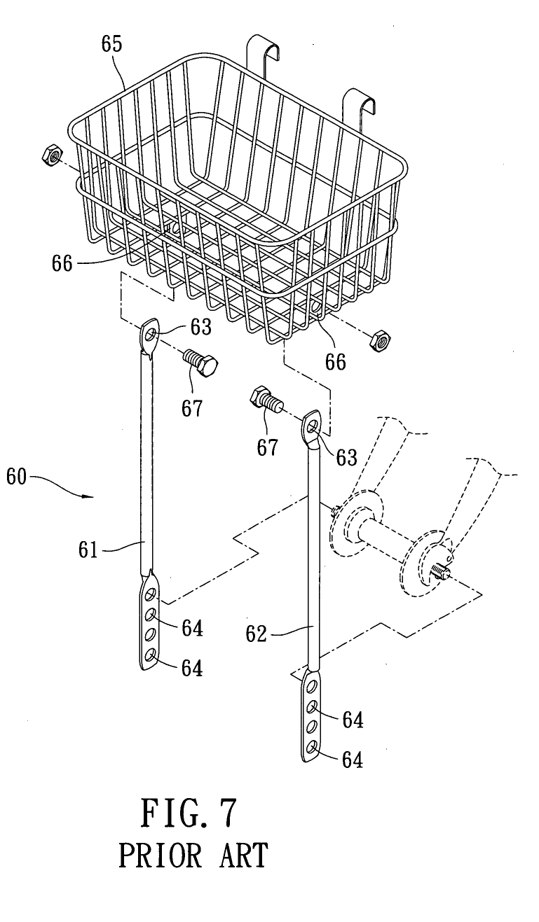

### DETAILED DESCRIPTION OF THE PREFERRED EMBODIMENTS

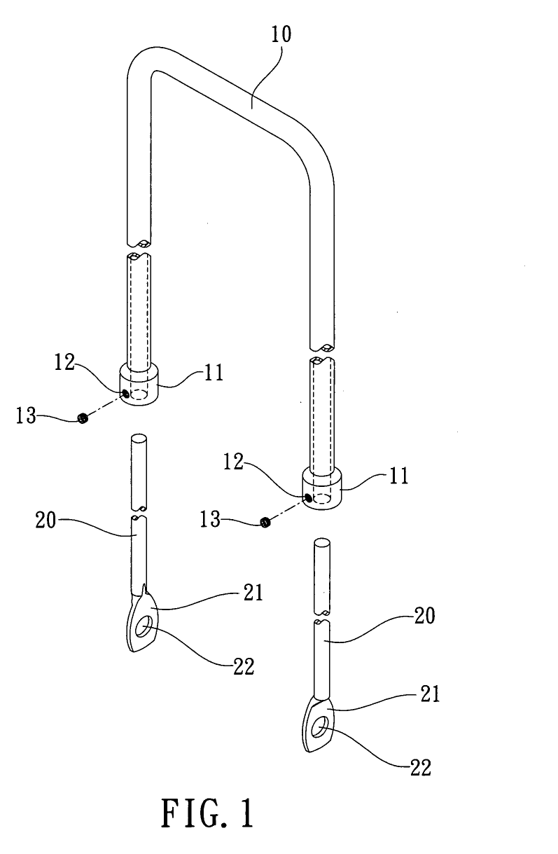

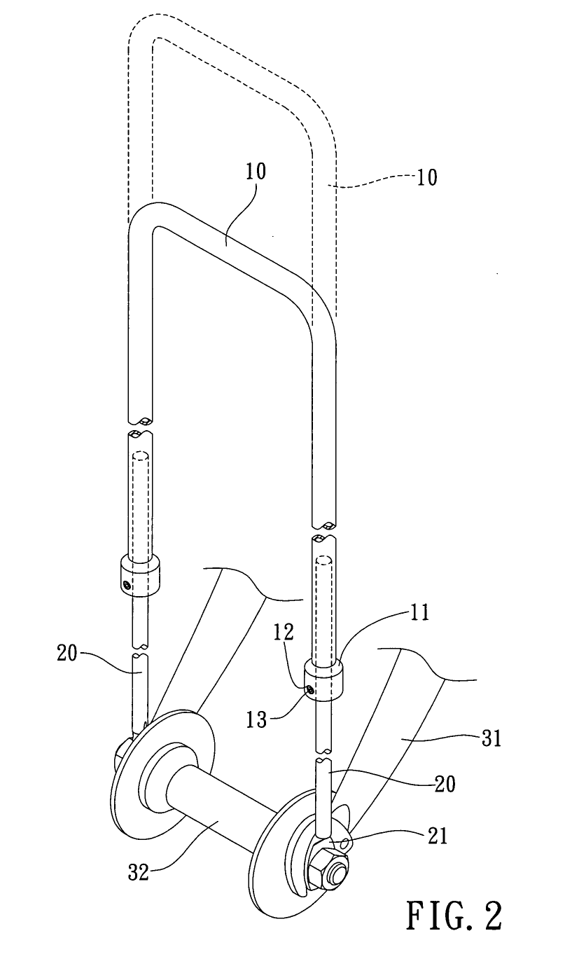

Referring to FIGS. 1 and 2, which show an adjustable bicycle basket support frame of the present invention structured to comprise an inverted U-shaped tube 10 and two rod members 20 respectively inserted into two end portions of the inverted U-shaped tube 10.

The aforementioned inverted U-shaped tube 10 is a hollow tube body, and an annular edge 11 is located on an outer circumference of each of the two ends of the inverted U-shaped tube 10. Moreover, a screw hole 12 that penetrates to the interior is defined in an outer circumference of each of the annular edges 11, and screws 13 respectively screw into the screw holes 12.

The two rod members 20 are respectively inserted into the two ends of the aforementioned inverted U-shaped tube 10. A securing portion 21 is located at a lower end of each of the rod members 20, and a through hole 22 is defined in each of the securing portions 21.

Accordingly, the rod members 20 of the inverted U-shaped tube 10 are adjustably extended or retracted up and down to a required height, and then the screws 13 at the end portions of the inverted U-shaped tube 10 are used to screw down and fixedly secure the rod members 20, thereby fabricating the adjustable bicycle basket support frame of the present invention.

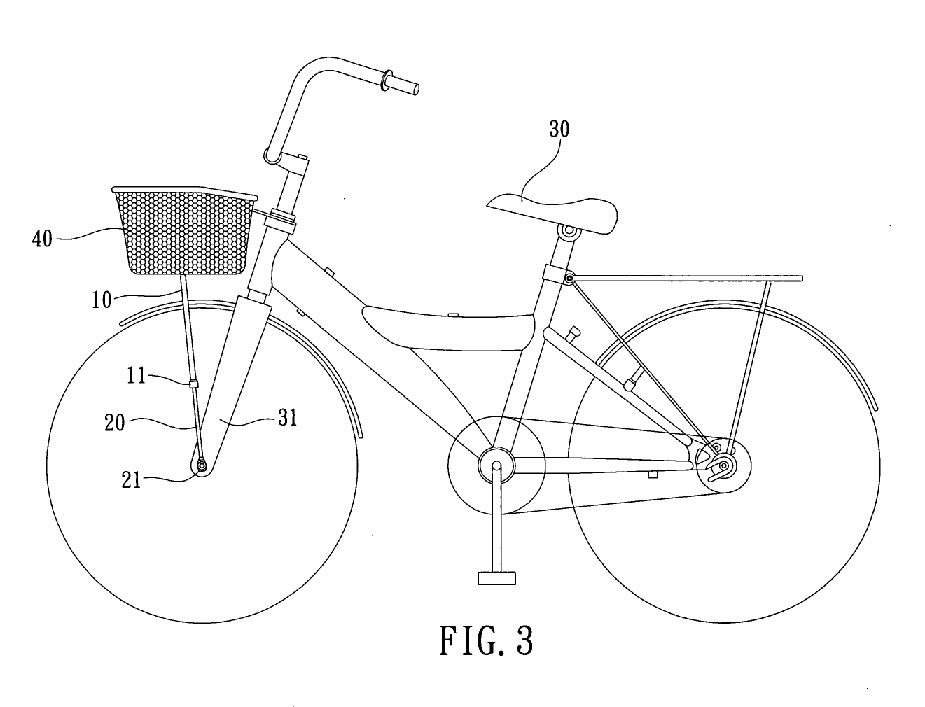

Referring to FIGS. 2 and 3, when using the present invention, the through holes 22 of the securing portions 21 at the lower ends of the rod members 20 of the support frame are first securely mounted to a hub 32 of a front fork 31 of a bicycle 30, and height of the inverted U-shaped tube 10 is adjusted to reach a bottom portion of a bicycle basket 40, thereby enabling supporting or fixedly securing the bicycle basket 40 of the bicycle 30, whereafter the screws 13 of the end portions of the inverted U-shaped tube 10 are tightly screwed down. Because up and down adjustment of the inverted U-shaped tube 10 is able to change height of the support frame, thus, the support frame of the present invention is applicable for use with all models of bicycles of different height to enable the bicycle basket to be fitted thereto, and strengthens supporting force for the bicycle basket, as well as increasing compatibility of the basket support frame. Furthermore, the single dimensions design of the present invention further improves convenience and efficiency of stock material and production and manufacture.

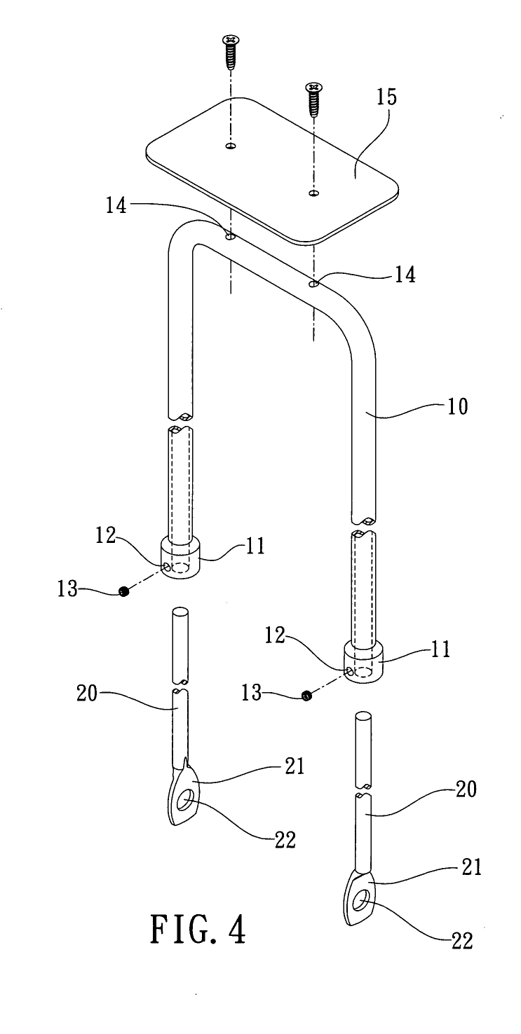

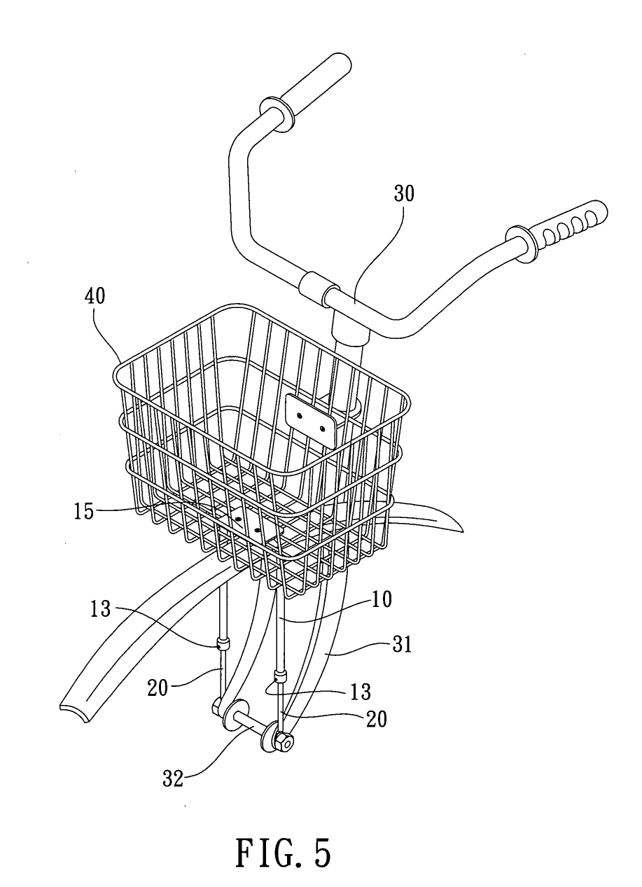

Referring to FIGS. 4 and 5, which show another embodiment of the present invention primarily comprising a plurality of securing holes 14 defined in a horizontal tube at a top end of the inverted U-shaped tube 10, and a clamping plate 15 is used to fixedly secure to the bottom portion of the bicycle basket 40 and provide support thereto, thereby enabling the bicycle basket 40 to be firmly fitted to a bicycle.

In conclusion, the simple structural design of the adjustable bicycle basket support frame of the present invention is applicable for use with all models of bicycles and for fitting and securing of bicycle baskets thereto, thereby effectively increasing compatibility of the bicycle basket support frame and further improves convenience and efficiency of stock material and production and manufacture.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An adjustable bicycle basket support frame, comprising an inverted U-shaped tube and two rod members, and characterized in that:
the inverted U-shaped tube is a hollow tube body, screw holes that penetrate to the interior are respectively defined in two end portions of the inverted U-shaped tube, and screws respectively screw into the screw holes;
the two rod members are respectively inserted into the two end portions of the inverted U-shaped tube, a securing portion is located at a lower end of each of the rod members, and a through hole is defined in each of the securing portions;
whereby the rod members of the inverted U-shaped tube are adjustably extended or retracted up and down to a required height, and then the screws at the end portions of the inverted U-shaped tube are used to screw down and fixedly secure the rod members.

2. The adjustable bicycle basket support frame according to claim 1, wherein an annular edge is located on an outer circumference of each of the two ends of the inverted U-shaped tube, and a screw hole that penetrates to the interior is defined in an outer circumference of each of the annular edges.

3. The adjustable bicycle basket support frame according to claim 1, wherein a plurality of securing holes are defined in a horizontal tube of a top end of the inverted U-shaped tube, which enable a clamping plate to be fixedly secured thereto.
